(19) United States
(12) Patent Application Publication
(10) Pub. No.: US 2024/0344598 A1
(43) Pub. Date: Oct. 17, 2024

(54) SPINDLE DRIVE DEVICE

(71) Applicant: Stabilus GmbH, Koblenz (DE)

(72) Inventors: Sven SCHNEIDER, Neuwied (DE); Lisa-Marie FETTWEIß, Kollig (DE); David BURBULLA, Koblenz (DE); Jürgen BLUM, Lahnstein (DE)

(21) Appl. No.: 18/633,974

(22) Filed: Apr. 12, 2024

(30) Foreign Application Priority Data
Apr. 17, 2023 (DE) 102023109536.6

(51) Int. Cl. F16H 25/20; F16H 25/24

(52) U.S. Cl. CPC F16H 25/20; F16H 2025/2075; F16H 2025/2481

(57) ABSTRACT

The invention relates to a spindle drive device comprising a spindle provided with an external thread, a thread engagement element which is in threaded engagement with the external thread of the spindle, a drive assembly having a drive unit which is configured to drive the spindle or the thread engagement element, wherein the spindle or the thread engagement element is connected to at least one connection unit for connecting the spindle drive device to a superordinate assembly that is not part of the spindle drive device.

According to the invention, it is provided that the spindle is a trapezoidal thread spindle made of carbon steel and is heat-treated by means of at least one thermochemical method.

### RELATED APPLICATION

The This U.S. patent application claims priority to German Patent Application No. 102023109536.6, filed on Apr. 17, 2023, which is hereby incorporated by reference in its entirety.

### DESCRIPTION

The invention relates to a spindle drive device comprising a spindle provided with an external thread, a thread engagement element which is in threaded engagement with the external thread of the spindle, a drive assembly having a drive unit which is configured to drive the spindle or the thread engagement element, wherein the spindle or the thread engagement element is connected to at least one connection unit for connecting the spindle drive device to a superordinate assembly that is not part of the spindle drive device.

Spindle drive devices are known, for example, in the automotive sector and are used, for example, for opening and closing doors and/or tailgates of motor vehicles. The requirements relating to wear and corrosion are very high in particular in the automotive sector, so that it is customary to use stainless steels to fulfill these requirements. At the same time, however, it is desired to provide cost-effective components. The entirety of the contradictory requirements cannot be fulfilled with the spindle drive devices currently known.

It is therefore an object of the present invention to provide an improved spindle drive device which can fulfill the entirety of the requirements. It is also an object to specify a superordinate assembly, in particular a vehicle having such a spindle drive device.

According to the invention, this object is achieved with regard to the spindle drive device by the subject matter of claim 1 and with regard to the superordinate assembly or the vehicle by the subject matter of claims 9 and 10.

Specifically, the object is achieved according to the invention by a spindle drive device comprising a spindle provided with an external thread, a thread engagement element which is in threaded engagement with the external thread of the spindle, a drive assembly having a drive unit which is configured to drive the spindle or the thread engagement element, wherein the spindle or the thread engagement element is connected to at least one connection unit for connecting the spindle drive device to a superordinate assembly that is not part of the spindle drive device, wherein the spindle is a trapezoidal thread spindle made of a carbon steel and is heat-treated by means of at least one thermochemical method.

Trapezoidal thread spindles, which can transmit high axial forces, are used in order to divert a rotational movement into a linear movement. In contrast to the prior art, the spindle drive device according to the invention has a trapezoidal thread spindles which is formed from a carbon steel. The raw material costs can thus be significantly reduced. The heat treatment of the spindle allows the requirements in terms of corrosion and wear to be fulfilled.

Thermochemical heat treatments which can improve the wear and corrosion properties of the spindle are, for example, methods such as carburization, boriding, carbonitriding, nitriding, nitrocarburizing, oxidizing, siliconizing or vanadating.

In an advantageous development of the invention, the spindle is heat-treated by means of a plurality of thermochemical methods. The properties of the spindle can thus be further improved.

The spindle is preferably heat-treated at least by means of a nitriding process, so that the spindle has a wear-resistant surface layer. The nitriding process is a method for surface hardening. The core of the component remains unchanged and retains its strength so that the wear and corrosion behavior of the spindle can be improved without affecting the core properties.

Nitriding methods such as nitrocarburization in gas or in a salt bath have proven to be particularly advantageous in particular with regard to costs.

The spindle is preferably oxidized so that it has a dark surface. The oxidation can advantageously follow a nitrocarburizing method in gas or in a salt bath.

In general, within the scope of the invention, the thermochemical treatments of carbonitriding, nitriding, and oxidizing can be components of the heat treatment.

However, other thermochemical methods for ensuring the corrosion requirements and wear-resistant surface layer properties are also possible.

Through post-oxidation, an additional thin oxide layer, which additionally improves the corrosion resistance, can be applied on the compound layer formed during nitriding.

According to an advantageous embodiment of the spindle drive device, the spindle can be connected to a first connection unit for connecting the spindle drive device to a superordinate assembly that is not part of the spindle drive device, and the thread engagement element can be connected to a second connection unit for connecting the spindle drive device to a superordinate assembly that is not part of the spindle drive device.

Alternatively, an actuating element or connection element connected directly or indirectly to the thread engagement element can be provided as a connection unit.

According to advantageous embodiments of the invention, the thread engagement element can be designed as a spindle nut or worm wheel.

The spindle drive device is preferably provided as an electrical spindle drive for opening and/or closing a movable vehicle part. The movable vehicle part can be, for example, a vehicle door, a tailgate, a hood, a cargo area door or a luggage compartment hatch.

A coordinate aspect of the invention relates to a superordinate assembly having a spindle drive device described above. The superordinate assembly can be a vehicle, for example. In this case, the spindle drive device can be provided for adjusting a vehicle part that is movable relative to a body of a vehicle. The movable vehicle part can be a vehicle door, a vehicle hatch, or a hood, for example. However, any objects which have a movable hatch are conceivable as a superordinate assembly.

The present invention is described below with reference to an exemplary embodiment.

In the drawings:

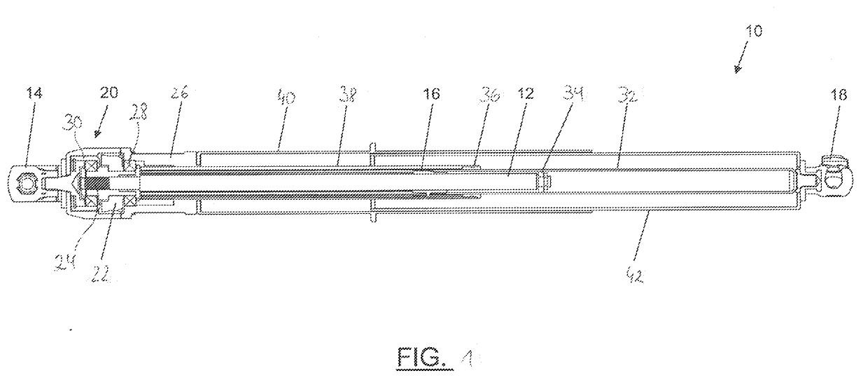

FIG. 1 shows a lateral cross-sectional view of a spindle drive device according to the invention.

FIG. 1 shows a spindle drive device 10 according to the invention, which is described by way of example for an electrical spindle drive as is used in the automotive field. Such spindle drives are provided for opening and/or closing a movable vehicle part such as a vehicle door or tailgate.

As can be seen, the spindle drive device 10 comprises a spindle 12 which is provided with an external thread and which is connected to a first connection unit 14 for connecting the spindle drive device 10 to a superordinate assembly, i.e., an assembly, such as a tailgate of a vehicle, which is not part of the spindle drive device 10, and a thread engagement element 16 which is in threaded engagement with the external thread of the spindle 12 and which is connected here as a spindle nut to a second connection unit 18 for connecting the spindle drive device 10 to a superordinate assembly, i.e., an assembly, such as a body of a vehicle, which is not part of the spindle drive device.

The spindle drive device 10 further comprises a drive assembly 20 which has an electric motor as a drive unit and is configured to drive the spindle 12.

According to the exemplary embodiment shown, an output shaft of the drive unit (not visible) carries a worm shaft which in turn meshes with a drive wheel 22 designed as a worm wheel. The drive wheel 22 is connected to the spindle 12 in a rotationally fixed manner by a spline shaft 24.

The drive assembly 20 is accommodated in a drive assembly housing 26, which is made of plastic here.

The drive wheel 22 and the spindle 12 are mounted relative to a cylindrical coupling element 30 and relative to the drive assembly housing 26 by a bearing 28.

The coupling element 36 connects the first connection unit 14 to the spindle 12 in such a way that a displacement of these two elements away from one another in an axial direction of the spindle 12 is prevented.

A steel tube 32 connected to the thread engagement element 16 is connected to the second connection unit 18.

In the sectional side view of FIG. 1, it can be seen how the spindle nut 16 is in threaded engagement with the spindle 12. Upon rotation of the spindle 12, the thread engagement element 16 is displaced in accordance with the direction of rotation and the type of the thread of the spindle 12 to the left or right in FIG. 1, so that the second connection unit 18 is displaced toward or away from the first connection unit 14 by the steel tube 32.

The right end of the spindle 12 in FIG. 1 is mounted by a guide ring 34 in the steel tube 32, which is mounted and accommodated in a guide tube 38 by a guide bush 36.

Furthermore, it can be seen in FIG. 1 that the first connection unit 14 is connected to a first cladding tube 40 and the second connection unit 18 is connected to a second cladding tube 42, wherein the second cladding tube 42 can dip into the first cladding tube 40 in a telescopic manner.

In particular in the case of electrical spindle drives, the use of trapezoidal thread spindles is advantageous, since these can transmit high axial forces. In contrast to the prior art, the spindle drive device according to the invention has a trapezoidal spindle which is formed from a carbon steel. The raw material costs can thus be significantly reduced. A heat treatment of the spindle 12 makes it possible to fulfill the requirements in terms of corrosion and wear.

Suitable cost-effective spindle raw materials are, for example, C-steels, such as C15 from the group of non-alloy case-hardening steels [DIN EN 10084], C25 from the group of non-alloy steels for quenching and tempering [DIN EN 10083-2] or other C-steels from general construction steels (including C-steels with additional symbols, such as C45U or C15R).

The spindle 12 is heat-treated at least by means of a nitriding process, so that it has a wear-resistant surface layer.

Nitriding methods such as nitrocarburization in gas or in a salt bath, which are particularly advantageous with regard to costs, allow surface hardening, wherein the core of the component remains unchanged and retains its strength. As a result, the wear and corrosion behavior of the spindle 12 can be improved without affecting its core properties. Through post-oxidation, an additional thin oxide layer, which additionally improves the corrosion resistance, can be applied on the compound layer formed during nitriding. The dark or black surface formed thereby is in part an additional requirement in the automotive industry.

As already mentioned, the spindle drive device 10 shown and described in FIG. 1 is not to be seen as limiting for the invention. Alternatively, for example, a connection element or actuating element connected directly or indirectly to the thread engagement element 16, which can be designed by way of example as a spindle nut or worm wheel within the scope of the invention, can be provided as a connection unit, which connection element or actuating element, according to the corresponding application, serves to connect to a vehicle part (body, door, tailgate, etc.).

According to an exemplary embodiment, the actuating element can also be a retaining strap connected to a vehicle door. Furthermore, it is possible for the thread engagement element 16 to be connected to the vehicle body by means of a connection element or a holder.

Likewise, the drive assembly can be arranged parallel or substantially perpendicular to a spindle axis.

1. A spindle drive device, comprising
a spindle provided with an external thread,
a thread engagement element which is in threaded engagement with the external thread of the spindle,
a drive assembly having a drive unit which is configured to drive the spindle or the thread engagement element, wherein the spindle or the thread engagement element is connected to at least one connection unit for connecting the spindle drive device to a superordinate assembly that is not part of the spindle drive device, characterized in that the spindle is a trapezoidal thread spindle made of carbon steel and is heat-treated by means of at least one thermochemical method.

2. The spindle drive device according to claim 1,
characterized in that the spindle is heat-treated by means of a plurality of thermochemical methods.

3. The spindle drive device according to claim 1,
characterized in that the spindle is heat-treated at least by means of a nitriding process, so that the spindle has a wear-resistant surface layer.

4. The spindle drive device according to claim 1,
characterized in that the spindle is oxidized so that it has a dark surface.

5. The spindle drive device according to claim 1,
characterized in that the spindle is connected to a first connection unit for connecting the spindle drive device to a superordinate assembly that is not part of the spindle drive device, and the thread engagement element is connected to a second connection unit for connecting the spindle drive device to a superordinate assembly that is not part of the spindle drive device.

6. The spindle drive device according to claim 5,
characterized in that an actuating element or connection element connected directly or indirectly to the thread engagement element is provided as the connection unit.

7. The spindle drive device according to claim 1,
characterized in that the thread engagement element is designed as a spindle nut or worm wheel.

8. The spindle drive device according to claim 1,
characterized in that the spindle drive device is provided as an electrical spindle drive for opening and/or closing a movable vehicle part.

9. A superordinate assembly having a spindle drive device according to claim 1.

10. A vehicle having a spindle drive device according to claim 1, wherein the spindle drive device is provided for adjusting a vehicle part that is movable relative to a body of the vehicle.
